(19) United States
(12) Patent Application Publication
(10) Pub. No.: US 2025/0079843 A1
(43) Pub. Date: Mar. 6, 2025

(54) VEHICLE TO LOAD INVERTER MODULE BASED ONBOARD CHARGER

(71) Applicant: GM GLOBAL TECHNOLOGY OPERATIONS LLC, Detroit, MI (US)

(72) Inventors: Minh-Khai Nguyen, Troy, MI (US); Lei Hao, Troy, MI (US); Samantha Gunter Miller, Berkley, MI (US)

(73) Assignee: GM GLOBAL TECHNOLOGY OPERATIONS LLC, Detroit, MI (US)

(21) Appl. No.: 18/461,647

(22) Filed: Sep. 6, 2023

(51) Int. Cl. H02J 3/32; B60L 50/60; B60L 53/22; B60L 55/00; H02M 1/42; H02M 3/335; H02M 7/219; H02P 27/06

(52) U.S. Cl. CPC H02J 3/322; B60L 50/60; B60L 53/22; B60L 55/00; H02M 1/4233; H02M 3/33573; H02M 3/33584; H02M 7/219; H02P 27/06; B60L 2210/10; B60L 2210/30; B60L 2210/40

(57) ABSTRACT

A vehicle to load inverter module (V2LIM) based onboard charger (OBC). The V2LIM based OBC may include an alternating current to direct current (AC/DC) converter having an AC/DC input and an AC/DC output, a direct current to direct current (DC/DC) converter having a DC/DC input and a DC/DC output, and a direct current to alternating current (DC/AC) converter having a DC/AC input and a DC/AC output, and a controller configured for controlling the AC/DC converter, the DC/DC converter, and the DC/AC converter according to a split-phase load powering mode.

### INTRODUCTION

The present disclosure relates to chargers operable with rechargeable energy storage systems (RESSs), such as but not necessarily limited to chargers operable for exchanging electrical power with an RESS included onboard a vehicle to store and supply electrical power for a traction motor.

A vehicle may include a rechargeable energy storage system (RESS) to provide electrical power for a traction motor operable for responsively propelling the vehicle. The RESS may include resources and capabilities sufficient for the RESS to be additionally used for storing and supplying electrical power for other systems beyond to the traction motor, such as for other loads and sources onboard the vehicle and/or for loads and sources offboard the vehicle, e.g., another vehicle or an external electrical grid. A vehicle having such an RESS may include a charger, which may be referred to as an onboard charger (OBC), to facilitate controlling, managing, and otherwise directing the exchange of electrical power between the RESS and the other loads and sources intended to be electrically connected therewith. The desire to exchange electrical power between the RESS, the traction motor, and/or other onboard and offboard loads and sources has in the past resulted in the OBC including dedicated or limited use components, circuits, systems, etc. having redundancy and inefficiencies and/or an inability to simultaneously exchange electrical power between more than one of the RESS, the traction motor, and/or the other onboard and offboard loads and sources.

### SUMMARY

One non-limiting aspect of the present disclosure relates to a vehicle to load inverter module (V2LIM) based onboard charger (OBC). The V2LIM based OBC may be configured for simultaneously exchanging electrical power between multiple loads and sources onboard and offboard a vehicle with minimal redundancy and inefficiencies. The V2LIM based OBC may be operable according to a plurality of powering modes, with the various powering modes being suitable for simultaneously facilitating electrical power exchange between single-phase and multi-phase alternating current (AC) loads and sources external to the vehicle and/or a rechargeable energy storage system (RESS) onboard the vehicle.

One non-limiting aspect of the present disclosure relates to a vehicle to load inverter module (V2LIM) based onboard charger (OBC) for a vehicle having a rechargeable energy storage system (RESS) to store and supply power electrical power for a traction motor. The V2LIM based OBC may include an electric vehicle supply equipment (EVSE) interface connectable to EVSE operating offboard the vehicle, a V2LIM interface connectable to an AC load operating offboard the vehicle, an alternating current to direct current (AC/DC) converter having an AC/DC input and an AC/DC output, with the AC/DC input electrically connecting to the EVSE interface, and a direct current to direct current (DC/DC) converter having a DC/DC input and a DC/DC output with the DC/DC input electrically connecting to the AC/DC output and the DC/DC output electrically connecting to the RESS, and a direct current to alternating current (DC/AC) converter having a DC/AC input and a DC/AC output with the DC/AC input electrically connecting to both of the AC/DC output and the DC/DC input and the DC/AC output electrically connecting to the V2LIM interface. The V2LIM based OBC may further include a controller configured for controlling the AC/DC converter, the DC/DC converter, and the DC/AC converter according to a plurality of powering modes.

The powering modes may include a split-phase load powering mode operable for controlling the DC/AC converter to convert a DC charge from either or both of the AC/DC output and the DC/DC input to a split-phase AC output suitable for powering the V2LIM interface.

The split-phase load powering mode may be operable for controlling the AC/DC converter to convert an AC input received from the EVSE via the EVSE interface to the DC charge.

The split-phase load powering mode may be operable for controlling the AC/DC converter to provide power factor correction (PFC) when converting the AC input to the DC charge.

The split-phase load powering mode may be operable for controlling the DC/DC converter to convert a DC input received from the RESS to the DC charge.

The powering modes may include an AC powering mode operable for controlling the AC/DC converter to convert an AC input received via the EVSE interface to a DC charge suitable for simultaneously use with the DC/AC converter and the DC/DC converter, whereby the DC/AC converter converts the DC charge to a split-phase AC output suitable for powering the V2LIM interface and the DC/DC converter simultaneously converts the DC charge to a DC output suitable for charging the RESS.

The powering modes may include a DC powering mode, the DC powering mode operable for controlling the DC/DC converter to convert a DC output from the RESS to a DC charge suitable for suitable for simultaneously use with the AC/DC converter and the DC/AC converter, whereby the DC/AC converter converts the DC charge to a split-phase AC output suitable for charging one vehicle via the V2LIM interface and the AC/DC converter simultaneously converts the DC charge to an AC output suitable for simultaneously charging another vehicle via the EVSE interface.

The powering modes may include an AC RESS powering mode operable for controlling the AC/DC converter to convert an AC input received via the EVSE interface to a DC charge suitable for use with the DC/DC converter, whereby the DC/DC converter converts the DC charge to a DC output suitable for charging the RESS.

The DC/DC converter may be a bidirectional, isolated LLC converter configured to provide variable input and output DC voltages with galvanic isolation.

The AC/DC converter may be a unidirectional rectifier with power factor correction (PFC) operable for converting a single-phase AC input received via the EVSE interface to a DC output operable with both of the DC/AC converter and the DC/DC converter.

The AC/DC converter may be a three-phase full-bridge bidirectional converter with power factor correction (PFC) operable for converting a three-phase AC input received via the EVSE interface to a DC output operable with both of the DC/AC converter and the DC/DC converter.

The DC/AC converter may be a split-phase inverter configured to selectively output 120 V and 240 V via the DC/AC output.

The V2LIM based OBC may include a housing enclosing each of the AC/DC converter, the DC/DC converter, and the DC/AC converter.

One non-limiting aspect of the present disclosure relates to a vehicle to load inverter module (V2LIM) based onboard charger (OBC). The V2LIM based OBC may include an alternating current to direct current (AC/DC) converter having an AC/DC input and an AC/DC output with AC/DC input electrically connectable with an AC input, a direct current to direct current (DC/DC) converter having a DC/DC input and a DC/DC output with the DC/DC input electrically connecting with the AC/DC output, a direct current to alternating current (DC/AC) converter having a DC/AC input and a DC/AC output with the DC/AC input electrically connecting with the AC/DC output and the DC/DC input and the DC/AC output electrically connectable with an AC output, and a controller configured for controlling the AC/DC converter, the DC/DC converter, and the DC/AC converter according to a split-phase load powering mode operable for controlling the DC/AC converter to convert a DC charge from either or both of the AC/DC output and the DC/DC input to a split-phase AC output suitable for powering the AC output.

The AC/DC converter may be a unidirectional rectifier with power factor correction (PFC) operable for converting a single-phase AC input to a DC output operable with both of the DC/AC converter and the DC/DC converter.

The AC/DC converter may be a three-phase full-bridge bidirectional converter with power factor correction (PFC) operable for converting a three-phase AC input to a DC output operable with both of the DC/AC converter and the DC/DC converter.

The DC/AC converter may be a split-phase inverter operable for selectively converting the DC charge to a 120 V output and a 240 V output.

The DC/DC converter may be a bidirectional, isolated LLC converter configured to provide variable input and output DC voltages with galvanic isolation.

One non-limiting aspect of the present disclosure relates to a non-transitory computer-readable storage medium having a plurality of non-transitory instructions stored thereon and executable with one or more processors to control a vehicle to load inverter module (V2LIM) based onboard charger (OBC) of a vehicle having a rechargeable energy storage system (RESS) to store and supply power electrical power for a traction motor. The non-transitory instructions may be operable for controlling an alternating current to direct current (AC/DC) converter of the V2LIM based OBC to convert a single-phase AC input to a first DC output with the single-phase AC input being provided from a source external to the vehicle and simultaneously controlling a direct current to direct current (DC/DC) converter of the V2LIM based OBC to convert the first DC output to a second DC output suitable for charging the RESS and a direct current to alternating current (DC/AC) converter of the V2LIM based OBC to convert the first DC output to a split-phase AC output suitable for powering a load external to the vehicle.

The non-transitory instructions may be operable for controlling the DC/AC converter to selectively generate the split-phase AC output at 120 V and 240 V.

These features and advantages, along with other features and advantages of the present teachings, may be readily apparent from the following detailed description of the modes for carrying out the present teachings when taken in connection with the accompanying drawings. It should be understood that even though the following figures and embodiments may be separately described, single features thereof may be combined to additional embodiments.

### BRIEF DESCRIPTION OF THE DRAWINGS

The accompanying drawings, which may be incorporated into and constitute a part of this specification, illustrate implementations of the disclosure and together with the description, serve to explain the principles of the disclosure.

FIG. 1 illustrates a vehicle to load inverter module (V2LIM) based onboard charger (OBC) in accordance with one non-limiting aspect of the present disclosure.

FIG. 2 illustrates a graph of a representative split-phase output waveform in accordance with one non-limiting aspect of the present disclosure.

FIG. 3 illustrates a flowchart of a method for controlling a V2LIM based OBC in accordance with one non-limiting aspect of the present disclosure.

FIG. 4 illustrates a rectifier configuration for the V2LIM based OBC in accordance with one non-limiting aspect of the present disclosure.

FIG. 5 illustrates a totem-pole configuration for the V2LIM based OBC in accordance with one non-limiting aspect of the present disclosure.

FIG. 6 illustrates a three-phase configuration for the V2LIM based OBC in accordance with one non-limiting aspect of the present disclosure.

### DETAILED DESCRIPTION

As required, detailed embodiments of the present disclosure may be disclosed herein; however, it may be understood that the disclosed embodiments may be merely exemplary of the disclosure that may be embodied in various and alternative forms. The figures may not be necessarily to scale; some features may be exaggerated or minimized to show details of particular components. Therefore, specific structural and functional details disclosed herein may need not to be interpreted as limiting, but merely as a representative basis for teaching one skilled in the art to variously employ the present disclosure.

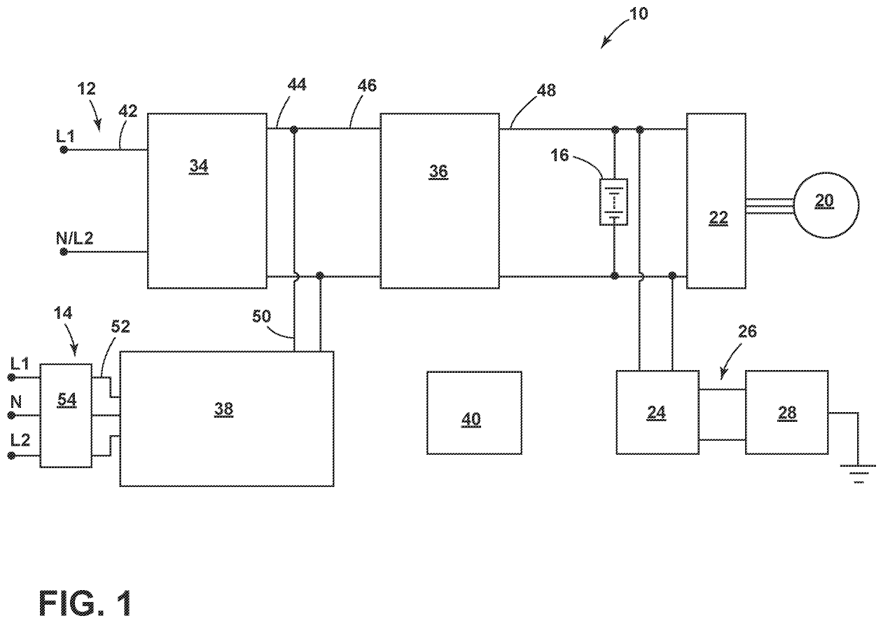

FIG. 1 illustrates a vehicle to load inverter module (V2LIM) based onboard charger (OBC) 10 in accordance with one non-limiting aspect of the present disclosure. The V2LIM based OBC 10 may be operable according to a plurality of powering modes for simultaneously and/or selectively exchanging electrical power between multiple loads and/or sources. One non-limiting aspect of the present disclosure contemplates the V2LIM based OBC 10 being particularly beneficial onboard a vehicle (not shown) to facilitate controlling, managing, and otherwise directing the exchange of electrical power therethrough, such as between a plurality of interfaces 12, 14 and/or a battery or other type of rechargeable energy storage system (RESS) 16. While the present disclosure fully contemplates the V2LIM based OBC 10 having alternative configurations and implementations when used with other devices, with respect to the illustrative vehicle, one of the interfaces 12 may be configured for exchanging electrical power with electric vehicle supply equipment (EVSE), which may be referred to as an EVSE interface 12, and one of the interfaces 14 may be configured for exchanging electrical power with a load, which may be referred to as a V2LIM 14 14. The RESS 16 may be configured for exchanging electrical power with a traction motor 20 via a power inverter module (PIM) 22 and/or with an accessory power module (APM) 24 used for powering a low voltage (LV) bus 26 and/or an auxiliary battery or other RESS 28.

The V2LIM based OBC 10 may include a plurality of unidirectional and/or bidirectional converters 34, 36, 38 operable in response to instructions, signals, etc. provided from a controller 40 to facilitate implementing the various power modes presented herein. The controller 40 may be operable for purposes of directing electrical power exchange between single-phase and/or multi-phase alternating current (AC) loads and sources external to the vehicle and/or the RESS 16 via the V2LIM based OBC 10. To this end, one non-limiting aspect of the present disclosure contemplates the plurality of converters 34, 36, 38 including an alternating current to direct current (AC/DC) converter 34, a direct current to direct current (DC/DC) converter 36, and a direct current to alternating current (DC/AC) converter 38. The AC/DC converter 34 may include an AC/DC input 42 and an AC/DC output 44, with the AC/DC input 42 electrically connecting to the EVSE interface 12. The DC/DC converter 36 may include a DC/DC input 46 and a DC/DC output 48, with the DC/DC input 46 electrically connecting to the AC/DC output 44 and the DC/DC output 48 electrically connecting to the RESS 16. The DC/DC converter 36 may include a DC/AC input 50 in a DC/AC output 52, with the DC/AC input 50 electrically connecting to both of the AC/DC output 44 and the DC/DC input 46 and the DC/AC output 52 electrically connecting to the V2LIM interface 14. The controller 40 may be configured for controlling AC/DC converter 34, the DC/DC converter 36, and the DC/DC converter 36 according to the plurality of powering modes.

As mentioned above, the EVSE and V2LIM interfaces 12, 14 may be connectable to a wide variety of loads and sources, with the loads and/or sources connectable thereto varying depending on various operating scenarios. The EVSE interface 12, for example, may be connectable to external EVSE sources offboard the vehicle, such as a charging station, another vehicle, an electrical power grid, etc., which depending on their configuration may be operable for sourcing single-phase and/or multi-phase, e.g., three-phase, AC power. The EVSE interface 12 may also being connectable to direct current (DC) sources with corresponding variations to the AC/DC converter 34, e.g., reconfiguring the AC/DC converter 34 as a DC/DC converter. The external EVSE sources may also operate periodically as external EVSE loads, i.e., loads capable of consuming AC power via the EVSE interface 12, and/or the EVSE interface 12 may be connectable to other types of loads having configurations limited to consuming AC power via the EVSE interface 12. Likewise, the V2LIM interface 14 may be connectable to external V2LIM sources offboard the vehicle, such as a charging station, another vehicle, an electrical power grid, which depending on their configuration may be operable for sourcing single-phase and/or multi-phase, e.g., three-phase, AC power. The V2LIM interface 14 may also being connectable to DC sources with corresponding variations to DC/AC converter 38, e.g., reconfiguring the DC/AC converter 38 as a DC/DC converter 36. The external V2LIM sources may also operate periodically as external V2LIM loads, i.e., a load capable of consuming AC power via the V2LIM interface 14, and/or the V2LIM interface 14 may be connectable to other types of loads having configurations limited to consuming AC power via the V2LIM interface 14.

The EVSE and V2LIM interfaces 12, 14 may include input and output (I/O) features suitable to facilitating electrical connections with the various loads and sources connectable thereto. The I/O features may include receptacles, outlets, prongs, connectors, tabs, pins, terminals, etc. to facilitate permanently and/or removably establishing electrical connections suitable for conducting electrical power. The EVSE and/or V2LIM interfaces 12, 14 may be included as part of a cable connection or interface included on the vehicle to facilitate removably connecting via cables or other wires to corresponding modes or sources, optionally at the same time. The EVSE and/or V2LIM interfaces 12, 14 may also be wireless or inductive interfaces capable of exchanging electrical power and creating electrical connections without physically inserting or connecting components together. The electrical connections to the EVSE interface 12, for example, may be established via several voltage terminal lines, which may include voltage lines L1 and a tied neutral (N)/line L2 connection, as appreciated in the art, such as via an SAE J1772 connector or another suitable connector type. Electrical connections to the V2LIM interface 14 may similarly include multiple voltage terminal lines L1, N, L2, which are shown for exemplary purposes to facilitate a split-phase interface, which may optionally include a filter 54, to support the exchange of split-phase electrical power.

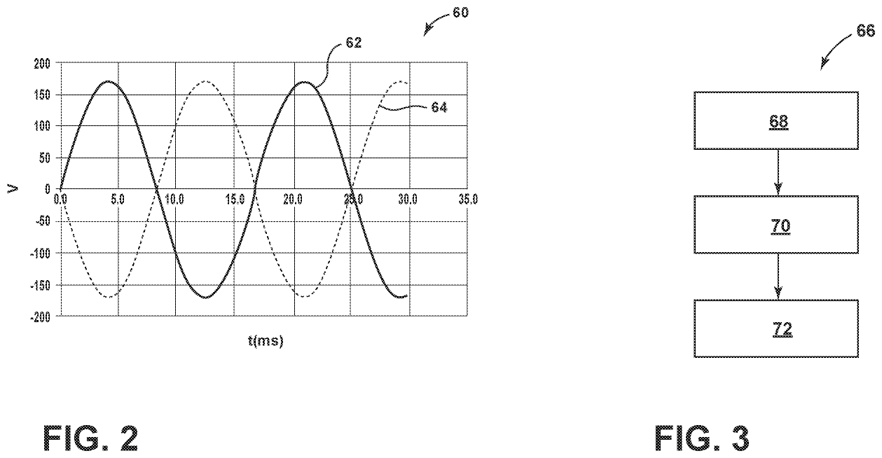

FIG. 2 illustrates a graph of a representative split-phase output waveform 60 of the split-phase electrical power in accordance with one non-limiting aspect of the present disclosure. The split-phase electrical power may include voltage waveforms 62, 64 having an equal amplitude that are 180° out-of-phase relative to one another. Root-mean-square (RMS) values of the illustrated voltage waveforms 62 and 64 with peaks of 170V correspond to an RMS voltage of 120V_{RMS}, i.e.,

$$\frac{{170}_{peak}}{\sqrt{2}} ≅ 120 {V}_{RMS} ,$$

with such a value being representative and non-limiting. For simplicity, the RMS subscript is omitted below for 120V and 240V example voltages. In such an example, a 120V embodiment of the external V2LIM load or source may be connected to an outlet presenting L1 (or L2) and N, thus providing a single-phase 120V output to the external V2LIM load or source. Alternatively, a 240V split-phase load could be connected to a plug presenting lines L1, L2, and N to provide 240V (between L1 and L2) and 120V (between L1 and N or L2 and N) power to the external V2LIM load or source. Using an SAE J1772 charging plug as an example, a third wire may be needed, and thus requires the three-wire connector L1, L2, and N as shown in FIG. 1. The exemplary presentation of the split-phase electrical power being exchanged relative to 120 V and 240 V is for non-limited purposes of the present disclosure fully contemplates the split-phase power being provided according to differing voltages characteristics (e.g., single-phase, split-phase, three-phase, 100 V, 120 V, 220 V, 230 V, etc.)

FIG. 3 illustrates a flowchart of a method 66 for controlling a V2LIM based OBC 10 in accordance with one non-limiting aspect of the present disclosure. The method may be facilitated with the controller 40 providing instructions, signals, etc. to facilitate controlling the AC/DC converter 34, the DC/DC converter 36, and the DC/AC converter 38 according to a plurality of powering modes. The controller 40 or other electronic control unit (ECU) (not shown) included onboard or offboard the vehicle may correspondingly include a non-transitory computer readable storage medium having a plurality of non-transitory instructions stored thereon and executable with one or more processors to facilitate selecting and implementing the powering modes. Block 68 relates to a connection process for identifying loads and/or services connected to the EVSE and V2LIM interfaces 12, 14 and/or loads or sources desired to be connected. The connection process may include the controller 40 exchanging information via the interfaces 12, 14 to identify one or more loads and/or sources connected thereto. Block 70 relates to a mode selection process for selecting a powering mode to be implemented. The mode selection process may include the controller 40 determining powering capabilities of the RESS 16 and/or the external sources, e.g., a capability of each to provide electrical power. Conversely, a similar determination may also be made for assessing a need or desire of the RESS 16 and/or the external loads to receive electrical. Block 72 relates to a control process for controlling the V2LIM based OBC 10 according to the powering mode selected to meet the powering needs and/or capabilities of the RESS 16 and external loads and sources.

One of the selectable powering modes may include a split-phase load powering mode operable for controlling the DC/AC converter 38 to convert a DC charge from either or both of the AC/DC output 44 and the DC/DC input 46 to a split-phase AC output suitable for powering the V2LIM interface 14. The split-phase load powering mode may be operable for controlling the AC/DC converter 34 to convert an AC input received from the EVSE via the EVSE interface 12 to the DC charge. The split-phase load powering mode may also be operable for controlling the AC/DC converter 34 to provide power factor correction (PFC) when converting the AC input to the DC charge. The split-phase load powering mode may include controlling the DC/DC converter 36 to convert a DC input received from the RESS 16 to the DC charge. One of the powering modes may include an AC powering mode operable for controlling the AC/DC converter 34 to convert an AC input received via the EVSE interface 12 to a DC charge suitable for simultaneously use with the DC/AC converter 38 and the DC/DC converter 36, whereby the DC/AC converter 38 may convert the DC charge to a split-phase AC output suitable for powering the V2LIM interface 14 and the DC/DC converter 36 simultaneously converts the DC charge to a DC output suitable for charging the RESS 16. One of the powering modes may include a DC powering mode operable for controlling the DC/DC converter 36 to convert a DC output from the RESS 16 to a DC charge suitable for suitable for simultaneously use with the AC/DC converter 34 and the DC/AC converter 38, whereby the DC/AC converter 38 converts the DC charge to a split-phase AC output suitable for charging one vehicle via the V2LIM interface 14 and the AC/DC converter 34 simultaneously converts the DC charge to an AC output suitable for simultaneously charging another vehicle via the EVSE interface 12. One of the powering modes may include an AC RESS 16 powering mode operable for controlling the AC/DC converter 34 to convert an AC input received via the EVSE interface 12 to a DC charge suitable for use with the DC/DC converter 36, whereby the DC/DC converter 36 converts the DC charge to a DC output suitable for charging the RESS 16.

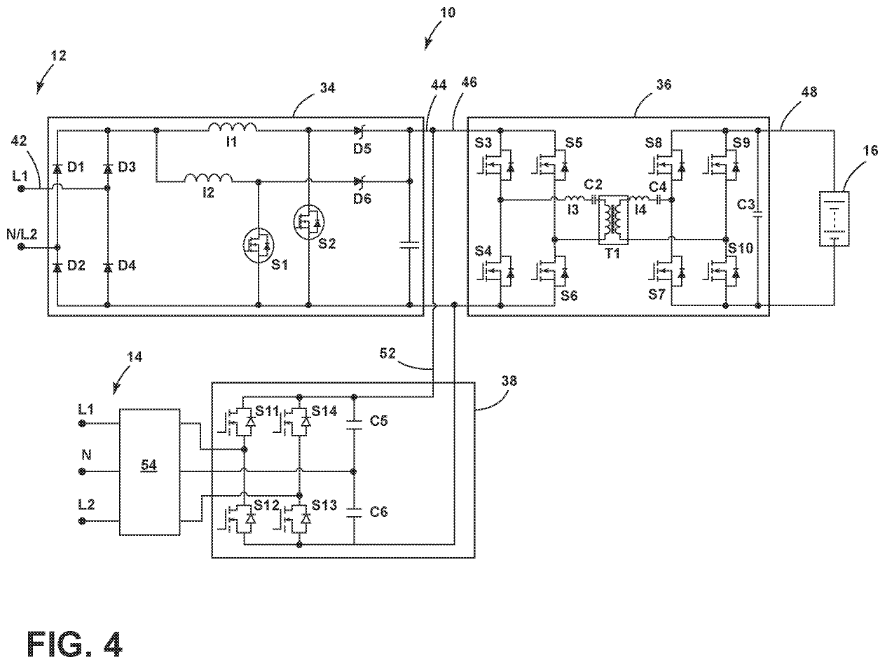

FIG. 4 illustrates a rectifier configuration for the V2LIM based OBC 10 in accordance with one non-limiting aspect of the present disclosure. The rectifier configuration may include the AC/DC converter 34 being configured to convert between AC single-phase and DC with a rectifier having power factor correction (PFC). The rectifier configuration may include the AC/DC converter 34 having a plurality of diodes D1, D2, D3, D4, D5, D6 operable with a plurality of switches S1, S2, a plurality of inductors 11, 12, and a capacitor C1 to facilitate converting between AC and DC power according to related control signals from the controller 40, i.e., signaling selectively timed to coordinate opening and closing of the switches S1, S2 according to the desired conversion. The rectifier configuration may include the DC/DC converter 36 being configured as a bidirectional, isolated DC/DC converter 36 configured to provide variable input and output DC voltages with galvanic isolation, which may include the DC/DC converter 36 having a plurality of switches S3, S4, S5, S6, S7, S8, S9, S10 operable with a plurality of inductors 13, 14 and a plurality of capacitors C2, C3, C4 to facilitate bidirectional DC buck and boosting via a transformer T1 according to related control signals from the controller 40, i.e., signaling selectively timed to coordinate opening and closing of the switches S3, S4, S5, S6, S7, S8, S9, S10 according to the desired conversion. The inductors 13, 14 and the capacitors C2, C4 may be helpful in creating a zero voltage switch (ZVS) or zero current switch (ZCS) events, which may in turn maximize DC-DC converter efficiency. The rectifier configuration may optionally have a unidirectional configuration whereby the AC/DC converter 34 may be a unidirectional rectifier with PFC operable for converting a single-phase input to DC. The DC/AC converter 38 may be configured to convert between single and split-phase AC and DC with a plurality of capacitors C5, C6 and selective control of a plurality of switches S11. S12, S13, S14, i.e., signaling from the controller 40 selectively timed to coordinate opening and closing of the switches S11. S12, S13, S14 according to the desired conversion.

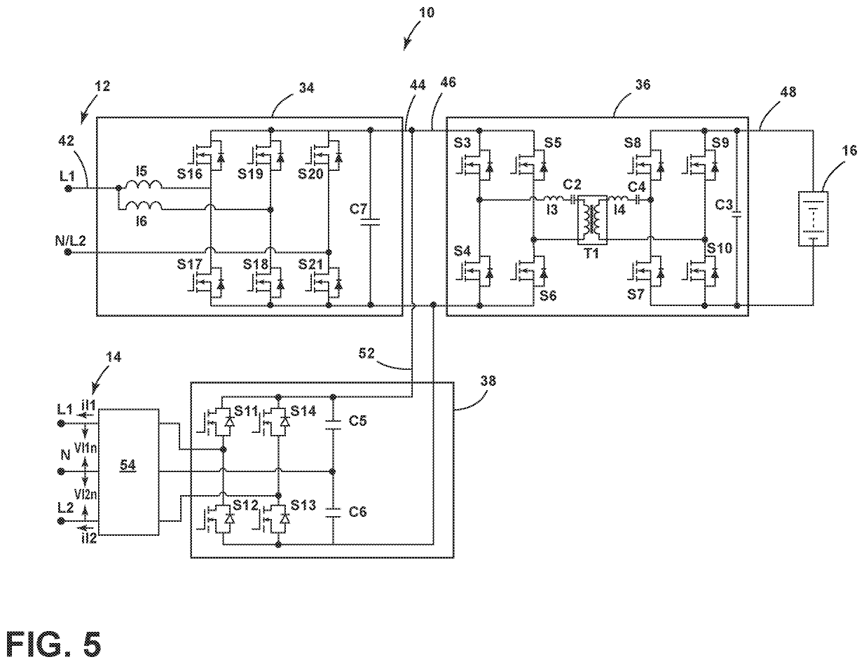

FIG. 5 illustrates a totem-pole configuration for the V2LIM based OBC 10 in accordance with one non-limiting aspect of the present disclosure. The totem-pole configuration may include the AC/DC converter 34 being operable for converting between single-phase AC and DC. The AC/DC converter 34 may be correspondingly configured as a bidirectional converter with power factor correction (PFC), which may include the AC/DC converter 34 having a plurality of switches S16, S17, S18, S19, S20, S21 operable with a plurality of inductors 15, 16 and a capacitor C7 to facilitate bidirectionally converting between AC and DC according to related control signals from the controller 40, i.e., signaling selectively timed to coordinate opening and closing of the switches S16, S17, S18, S19, S20, S21 according to the desired conversion. The totem-pole configuration may include the DC/DC converter 36 and the DC/AC converter 38 configured in the manner described above with respect to FIG. 4.

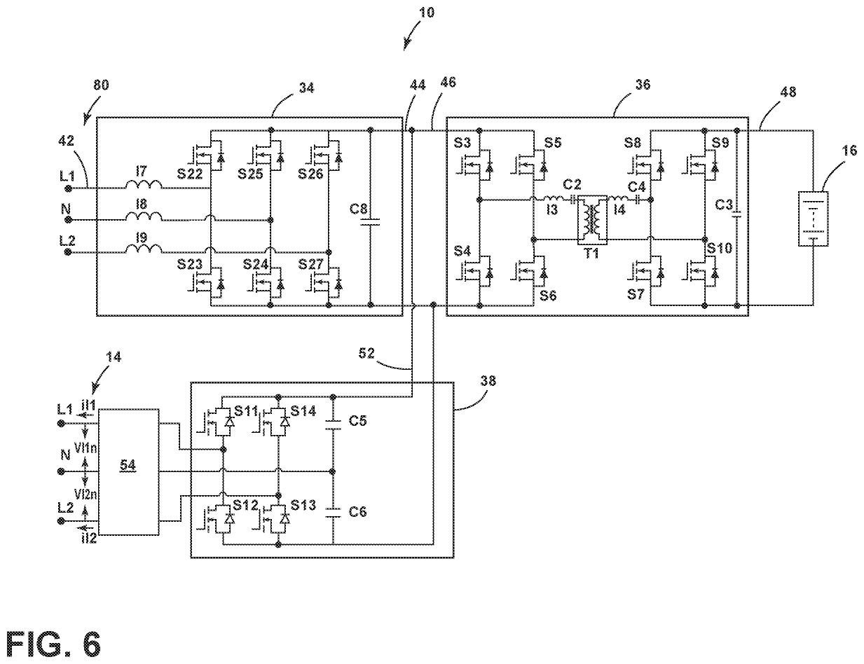

FIG. 6 illustrates a three-phase configuration for the V2LIM based OBC 10 in accordance with one non-limiting aspect of the present disclosure. The three-phase configuration may include the AC/DC converter 34 having the EVSE interface 12 configured for converting between three-phase AC and DC. The AC/DC converter 34 may include a three-phase interface 80 with a plurality of switches S22, S23, S24, S25, S26 interacting with a plurality of inductors 17, 18, 19 and a capacitor C8 to facilitate bidirectionally converting between three-phase AC and DC according to related control signals from the controller 40, i.e., signaling selectively timed to coordinate opening and closing of the switches according to the desired conversion. The three-phase configuration may include the DC/DC converter 36 in the DC/AC converter 38 configured in a manner described above with respect to FIG. 4

As supported above, the present disclosure relates to OBC 10, which may also be referred to as an onboard charger module (OBCM), that not only provides AC charging to a RESS 16, battery, etc. via AC input provide via the EVSE interface 12 but that can also simultaneously discharge the power to a load connected via the V2LIM interface 14. The proposed configuration may provide the AC power to the load at both 120V and 240V while the system is charging the RESS 16. The OBC 10 may include an architecture which allows the one device to provide both OBC 10 and V2LIM functions, i.e., to use AC input to the EVSE interface 12 to charge the RESS 16 while providing power to an external load connected via the V2LIM interface 14. A bidirectional isolated LLC DC-DC converter may be used to provide variable input/output DC voltage and galvanic isolation. A unidirectional rectifier with PFC to reduce circuit componentry. An AC-DC stage may be provided via totem-pole PFC for efficiency and to support vehicle-to-vehicle (V2V) charging features. A split-phase inverter may be included for supporting vehicle-to-load (V2L) charging features with 120V/240V power capability. A size of each stage, PFC, split-phase inverter, isolated DC-DC converter, etc. may be optimized depending on the desired power levels. A modular design for each stage may be included such that a single PCB and housing design may be used and different components may be populated/depopulated depending on the application. Such a flexible inverter topology may be used to provide single-phase (at multiple voltages like 120, 220, 230 V), split-phase, and/or three-phase output. During AC charging, the split DC/AC converter 38 may be deactivated if AC charging is desired to be limited to the RESS 16. If V2L function is requested during AC charging, the split DC/AC converter 38 may be enabled to provide 120V/240V power.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. “A”, “an”, “the”, “at least one”, and “one or more” are used interchangeably to indicate that at least one of the items is present. A plurality of such items may be present unless the context clearly indicates otherwise. All values of parameters (e.g., of quantities or conditions), unless otherwise indicated expressly or clearly in view of the context, including the appended claims, are to be understood as being modified in all instances by the term “about” whether or not “about” actually appears before the value. A component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims. Although several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed is:

1. A vehicle to load inverter module (V2LIM) based onboard charger (OBC) for a vehicle having a rechargeable energy storage system (RESS) to store and supply power electrical power for a traction motor, comprising:
an electric vehicle supply equipment (EVSE) interface connectable to EVSE operating offboard the vehicle;
a V2LIM interface connectable to an AC load operating offboard the vehicle;
an alternating current to direct current (AC/DC) converter having an AC/DC input and an AC/DC output, with the AC/DC input electrically connecting to the EVSE interface;
a direct current to direct current (DC/DC) converter having a DC/DC input and a DC/DC output, with the DC/DC input electrically connecting to the AC/DC output and the DC/DC output electrically connecting to the RESS;
a direct current to alternating current (DC/AC) converter having a DC/AC input and a DC/AC output, with the DC/AC input electrically connecting to both of the AC/DC output and the DC/DC input and the DC/AC output electrically connecting to the V2LIM interface; and
a controller configured for controlling the AC/DC converter, the DC/DC converter, and the DC/AC converter according to a plurality of powering modes.

2. The V2LIM based OBC according to claim 1, wherein:
the powering modes include a split-phase load powering mode, the split-phase load powering mode operable for controlling the DC/AC converter to convert a DC charge from either or both of the AC/DC output and the DC/DC input to a split-phase AC output suitable for powering the V2LIM interface.

3. The V2LIM based OBC according to claim 2, wherein:
the split-phase load powering mode is operable for controlling the AC/DC converter to convert an AC input received from the EVSE via the EVSE interface to the DC charge.

4. The V2LIM based OBC according to claim 2, wherein:
the split-phase load powering mode is operable for controlling the AC/DC converter to provide power factor correction (PFC) when converting the AC input to the DC charge.

5. The V2LIM based OBC according to claim 2, wherein:
the split-phase load powering mode is operable for controlling the DC/DC converter to convert a DC input received from the RESS to the DC charge.

6. The V2LIM based OBC according to claim 1, wherein:
the powering modes include an AC powering mode, the AC powering mode operable for controlling the AC/DC converter to convert an AC input received via the EVSE interface to a DC charge suitable for simultaneously use with the DC/AC converter and the DC/DC converter, whereby the DC/AC converter converts the DC charge to a split-phase AC output suitable for powering the V2LIM interface and the DC/DC converter simultaneously converts the DC charge to a DC output suitable for charging the RESS.

7. The V2LIM based OBC according to claim 1, wherein:
the powering modes include a DC powering mode, the DC powering mode operable for controlling the DC/DC converter to convert a DC output from the RESS to a DC charge suitable for suitable for simultaneously use with the AC/DC converter and the DC/AC converter, whereby the DC/AC converter converts the DC charge to a split-phase AC output suitable for charging one vehicle via the V2LIM interface and the AC/DC converter simultaneously converts the DC charge to an AC output suitable for simultaneously charging another vehicle via the EVSE interface.

8. The V2LIM based OBC according to claim 1, wherein:
the powering modes include an AC RESS powering mode, the AC RESS powering mode operable for controlling the AC/DC converter to convert an AC input received via the EVSE interface to a DC charge suitable for use with the DC/DC converter, whereby the DC/DC converter converts the DC charge to a DC output suitable for charging the RESS.

9. The V2LIM based OBC according to claim 1, wherein:
the DC/DC converter is a bidirectional, isolated converter configured to provide variable input and output DC voltages with galvanic isolation.

10. The V2LIM based OBC according to claim 1, wherein:
the AC/DC converter is a unidirectional rectifier with power factor correction (PFC) operable for converting a single-phase AC input received via the EVSE interface to a DC output operable with both of the DC/AC converter and the DC/DC converter.

11. The V2LIM based OBC according to claim 1, wherein:
the AC/DC converter is a bidirectional converter with power factor correction (PFC) operable for converting a DC input received via the DC/DC converter to AC output operable for providing AC power via EVSE interface.

12. The V2LIM based OBC according to claim 1, wherein:
the AC/DC converter is a three-phase full-bridge bidirectional converter with power factor correction (PFC) operable for converting a three-phase AC input received via the EVSE interface to a DC output operable with both of the DC/AC converter and the DC/DC converter or converting a DC input received via the DC/DC converter to AC output to provide AV power via EVSE interface.

13. The V2LIM based OBC according to claim 1, wherein:
the DC/AC converter is a split-phase inverter configured to selectively output 120 V and 240 V via the DC/AC output.

14. The V2LIM based OBC according to claim 1, further comprising:
a housing enclosing each of the AC/DC converter, the DC/DC converter, and the DC/AC converter.

15. A vehicle to load inverter module (V2LIM) based onboard charger (OBC), comprising:
an alternating current to direct current (AC/DC) converter having an AC/DC input and an AC/DC output, with AC/DC input electrically connectable with an AC input;
a direct current to direct current (DC/DC) converter having a DC/DC input and a DC/DC output, with the DC/DC input electrically connecting with the AC/DC output;
a direct current to alternating current (DC/AC) converter having a DC/AC input and a DC/AC output, with the DC/AC input electrically connecting with the AC/DC output and the DC/DC input and the DC/AC output electrically connectable with an AC output; and
a controller configured for controlling the AC/DC converter, the DC/DC converter, and the DC/AC converter according to a split-phase load powering mode, the split-phase load powering mode operable for controlling the DC/AC converter to convert a DC charge from either or both of the AC/DC output and the DC/DC input to a split-phase AC output suitable for powering the AC output.

16. The V2LIM based OBC according to claim 14, wherein:
the AC/DC converter is a unidirectional rectifier with power factor correction (PFC) operable for converting a single-phase AC input to a DC output operable with both of the DC/AC converter and the DC/DC converter.

17. The V2LIM based OBC according to claim 14, wherein:
the AC/DC converter is a three-phase full-bridge bidirectional converter with power factor correction (PFC) operable for converting a three-phase AC input to a DC output operable with both of the DC/AC converter and the DC/DC converter.

18. The V2LIM based OBC according to claim 14, wherein:
the DC/AC converter is a split-phase inverter operable for selectively converting the DC charge to a 120 V output and a 240 V output.

19. The V2LIM based OBC according to claim 14, wherein:
the DC/DC converter is a bidirectional, isolated LLC converter configured to provide variable input and output DC voltages with galvanic isolation.

20. A non-transitory computer-readable storage medium having a plurality of non-transitory instructions stored thereon and executable with one or more processors to control a vehicle to load inverter module (V2LIM) based onboard charger (OBC) of a vehicle having a rechargeable energy storage system (RESS) to store and supply power electrical power for a traction motor, the non-transitory instructions operable for:
controlling an alternating current to direct current (AC/DC) converter of the V2LIM based OBC to convert a single-phase AC input to a first DC output, the single-phase AC input provided from a source external to the vehicle; and
simultaneously controlling:
a direct current to direct current (DC/DC) converter of the V2LIM based OBC to convert the first DC output to a second DC output suitable for charging the RESS; and
a direct current to alternating current (DC/AC) converter of the V2LIM based OBC to convert the first DC output to a split-phase AC output suitable for powering a load external to the vehicle.
